(19) United States
(12) Patent Application Publication
(10) Pub. No.: US 2014/0307066 A1
(43) Pub. Date: Oct. 16, 2014

(54) METHOD AND SYSTEM FOR THREE DIMENSIONAL VISUALIZATION OF DISPARITY MAPS

(71) Applicant: THOMSON LICENSING, Issy de Moulineaux (FR)

(72) Inventors: Lihua Zhu, San Jose, CA (US); Richard E. Goedeken, Santa Clarita, CA (US); Richard W. Kroon, Lake Balboa, CA (US)

(73) Assignee: THOMSON LICENSING, Issy de moulineaux (FR)

(21) Appl. No.: 14/356,913

(22) PCT Filed: Nov. 27, 2012
(86) PCT No.: PCT/US2012/066581

§ 371 Date: May 8, 2014

Related U.S. Application Data
(60) Provisional application No. 61/563,456, filed on Nov. 23, 2011.

(51) Int. Cl. H04N 13/00

(52) U.S. Cl. CPC H04N 13/0018; H04N 13/0022
USPC 348/51

(57) ABSTRACT

The present invention relates to a three dimensional video processing system. In particular, the present invention is directed towards a method and system for the three dimensional (3D) visualization of a disparity map. The 3D visualization system selectably provides 3D surface visualization for disparity map, 3D bar visualization for the disparity map and the 3D line meshing visualization for the disparity map. Based on the 3D visualization system, a user can analyze the disparity map of a stereo content, and then adjusting for different viewing environments to promote comfortable viewing standards.

### PRIORITY CLAIM

This application claims the benefit of U.S. Provisional Patent Application No. 61/563456, filed Nov. 23, 2011 entitled “METHOD AND SYSTEM FOR THREE DIMENSIONAL VISUALIZATION OF DISPARITY MAPS” which is incorporated herein by reference.

### FIELD OF THE INVENTION

The present invention relates to a three dimensional video processing system. In particular, the present invention is directed towards a method and system for the three dimensional (3D) visualization of a disparity map.

### BACKGROUND

Hyper convergence exists if an object in a stereogram is too close for a viewer. For example, when the object is closer than half the distance from a viewer to the screen, it would require the viewer's eyes to converge excessively and make his or her eyes crossed. Hyper convergence will cause the viewer's eyes visual discomfort or double vision. Generally, this kind of distortion is caused by that the recorded objects are set too close to the camera or by using too sharp an angle of convergence with toedin cameras. The hyper convergence is that if an object in a stereogram is too far for a viewer, for example it is farther than twice the distance from a viewer to the screen; it would require the viewer's eyes to diverge more than one degree. It will cause visual discomfort or double vision. Generally, this kind of distortion is caused by that the focal length of lens is too long or by using too much divergence with toedin cameras.

To address discomfort, the present disclosure proposes a 3D visualization system for a disparity map. The 3D visualization system contains 3D surface visualization for disparity map, 3D bar visualization for the disparity map and the 3D line meshing visualization for the disparity map. Based on the 3D visualization system, a user can analyze the disparity map of a stereo content, and then adjusting for different viewing environments to promote comfortable viewing standards. The visualization system of the present disclosure can give film makers important guidance not only on shots that may fall outside viewer comfort thresholds, but also on the visualization of uncomfortable noise.

### SUMMARY OF THE INVENTION

In one aspect, the present invention involves a method for receiving a disparity map having a plurality of values, selecting a portion of said plurality of values to generate a sparse disparity map, filtering said values of said sparse disparity map to generate is a smoothed disparity map, generating a color map in response to a user input, applying said color map to said smoothed disparity map to generate a visualization of said smoothed disparity map; and displaying said visualization of said smoothed disparity map.

In another aspect, the invention also involves an apparatus comprising an input for receiving a disparity map having a plurality of values, a processor for selecting a portion of said plurality of values to generate a sparse disparity map, filtering said values of said sparse disparity map to generate a smoothed disparity map, generating a color map in response to a user input, applying said color map to said smoothed disparity map to generate a visualization of said smoothed disparity map and a video processing circuit for generating a signal representative of said visualization of said smoothed disparity map.

In one aspect, the present invention involves a method for method of generating a visualization of a 3D disparity map comprising the steps of receiving a signal comprising a 3D image, generating a disparity map from said 3D image, wherein said disparity map has a plurality of values, selecting a portion of said plurality of values to generate a sparse disparity map, filtering said values of said sparse disparity map to generate a smoothed disparity map, generating a color map in response to a user input, applying said color map to said smoothed disparity map to generate a visualization of said smoothed disparity map and generating a signal representative of said visualization of said smoothed disparity map.

### BRIEF DESCRIPTION OF THE DRAWINGS

FIG. 1 is a block diagram of an exemplary embodiment of a 3D video processing system according to the present invention.

FIG. 2 is a block diagram of an exemplary two pass system according to the present invention.

FIG. 3 is a block diagram of an exemplary one pass system according to the present invention

FIG. 4 is a block diagram of an exemplary live video feed system according to the present invention.

FIG. 5 is a flowchart that illustrates an exemplary embodiment of a 3D visualization system for the disparity map 500 according to the present invention.

FIG. 6 is a graphical representation of the color bar texture according to the present invention.

FIG. 7 is a graphical representation of the color map texture according to the present invention

FIG. 8 is a workflow of the disparity map visualization in 3D surface according to the present invention

FIG. 9 is the data structure of the vertex for the surface according to the present invention

FIG. 10 is a display unit in the disparity display processing unit corresponding to a pixel in the disparity map according to the present invention

FIG. 11 is an exemplary algorithm for finding the zdepth value according to the present invention

FIG. 12 is an algorithm for generating the interpolated disparity pixel according to the present invention

FIG. 13 is a contour map for a disparity surface according to the present invention

FIG. 14 is an exemplary illustration of the four possible side contours according to the present invention

FIG. 15 is a graphical example of the 3D surface visualization for the disparity map according to the present invention

FIG. 16 is a workflow for a disparity map visualization in 3D bar according to the present invention

FIG. 17 is a disparity display processing unit corresponding to a pixel in the disparity map according to the present invention

FIG. 18 is the data structure of each vertex according to the present invention

FIG. 19 is an example of a graph of an interpolation of the relation between the position of reference disparity vertex and connected vertexes according to the present invention

FIG. 20 is an example of a procedure for side bar drawing according to the present invention

FIG. 21 is an example of the 3D bar visualization result for the disparity map according to the present invention

FIG. 22 is a Workflow of Disparity Map Visualization in 3D Line Meshing according to the present invention

FIG. 23 is an example of 3D line meshing visualization result for the disparity map according to the present invention.

### DETAILED DESCRIPTION

The characteristics and advantages of the present invention will become more apparent from the following description, given by way of example. One embodiment of the present invention may be included within an integrated video processing system. Another embodiment of the present invention may comprise discrete elements and/or steps achieving a similar result. The exemplifications set out herein illustrate preferred embodiments of the invention, and such exemplifications are not to be construed as limiting the scope of the invention in any manner.

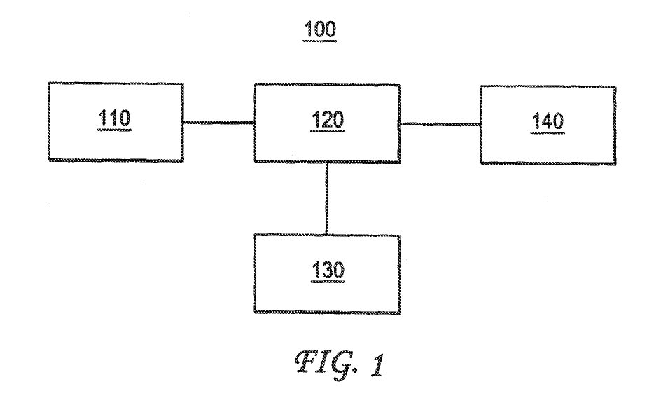

Referring to FIG. 1, a block diagram of an exemplary embodiment of a 3D video processing system 100 according to the present invention is shown. FIG. 1 shows a source of a 3D video stream or image 110, a processor 120, a memory 130, and a display device 140.

The source of a 3D video stream 110, such as a storage device, storage media, or a network connection, provides a time stream of two images. Each of the two images is a view from a different perspective of the same scene. Thus, the two images will have slightly different characteristics in that the scene is viewed from different angles separated by a horizontal distance, similar to what would be seen by each individual eye in a human. Each image may contain information not available in the other image due to some objects in the foreground of one image hiding information available in the second image due to camera angle. For example, one view taken closer to a corner would see more of the background behind the corner than a view take further away from the corner. This results in only one point being available for a disparity map and therefore generating a less reliable disparity map.

The processor 120 receives the two images and generates a disparity value for a plurality of points in the image. These disparity values can be used to generate a disparity map, which shows the regions of the image and their associated image depth. The perceived image depth of a portion of the image is related in some known linear or nonlinear way to the disparity value at that point. The processor then stores these disparity values on a memory 130 or the like.

After further processing by the processor 120 according to the present invention, the apparatus can display to a user a disparity map for a pair of images, or can generate a disparity time comparison according to the present invention. These will be discussed in further detail with reference to other figures. These comparisons are then displayed on a display device, such as a monitor, or a led scale, or similar display device.

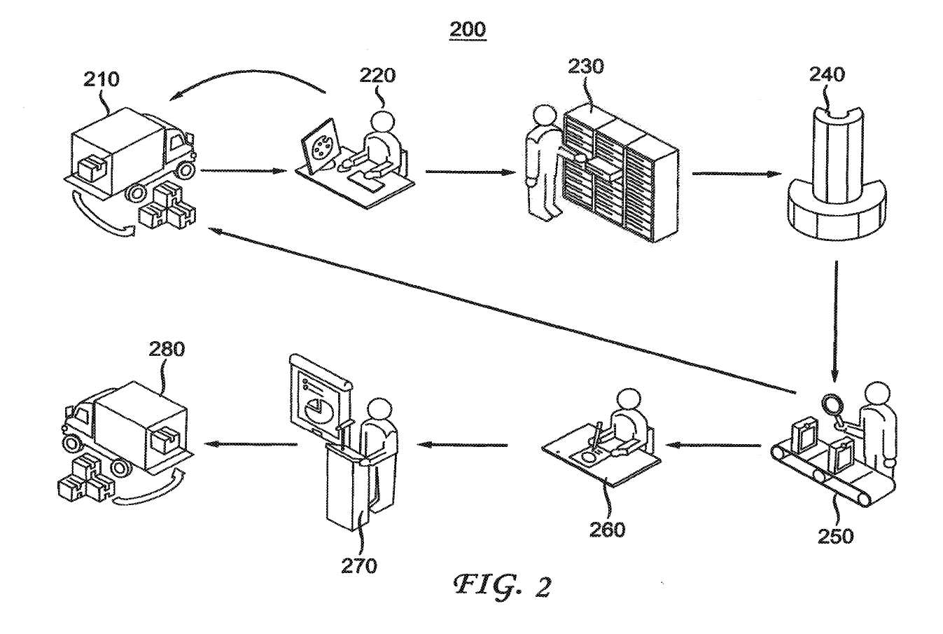

Referring now to FIG. 2, a block diagram of an exemplary two pass system 200 according to the present invention is shown. The two pass system is operative to receive content 210 via storage media or network. The system then qualifies the content 220 to ensure that the correct content has been received. If the correct content has not been received, it is returned to the supplier or customer. If the correct content has been received, it is loaded 230 into the system according to the present invention.

Once loaded into the exemplary 3D video processing system according to the present invention, the 3D video images are analyzed to calculate and record depth information 240. This information is stored in a storage media. After analysis, an analyst or other user will then review 250 the information stored in the storage media and determine if the some or all of the analysis must be repeated with different parameters. The analyst may also reject the content. A report is then prepared for the customer 260, and the report is presented to the customer 270 and any 3D video content is returned to the customer 280. The two pass processes permits an analyst to optimize the results based on a previous analysis.

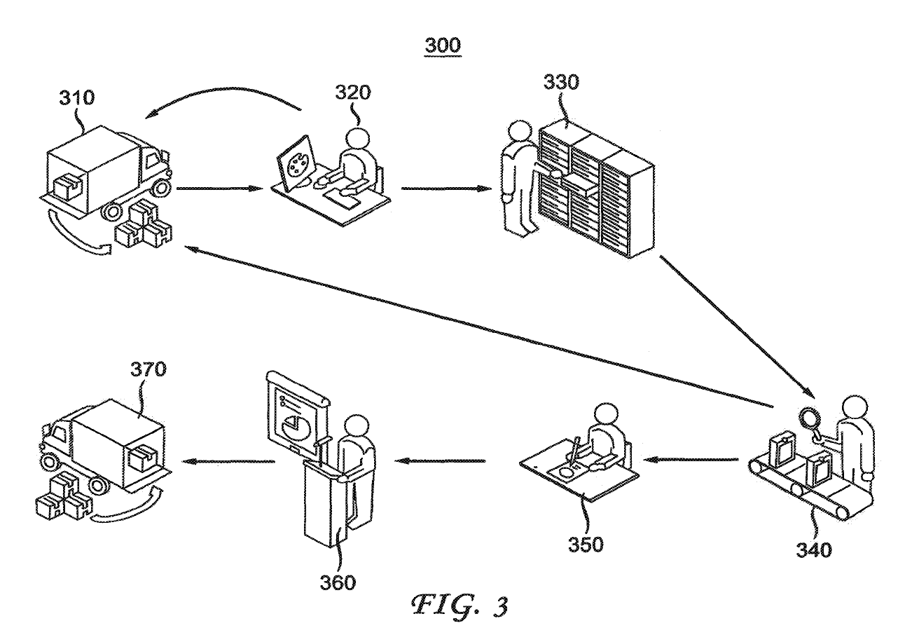

Referring now to FIG. 3 a block diagram of an exemplary one pass system according to the present invention is shown. The one pass system is operative to receive content 310 via storage media or network. The system then qualifies the content 320 to ensure that the correct content has been received. If the correct content has not been received, it is returned to the supplier or customer. If the correct content has been received, it is loaded 330 into the system according to the present invention.

Once loaded into the exemplary 3D video processing system according to the present invention, the 3D video images are analyzed to calculate and record depth information 340, generate depth map and perform automated analysis live during playback. This information is may stored in a storage media. An analyst will review the generated information. Optionally the system may dynamically downsample to maintain realtime playback. A report may optionally be prepared for the customer 350, and the report is presented to the customer 360 and any 3D video content is returned to the customer 370.

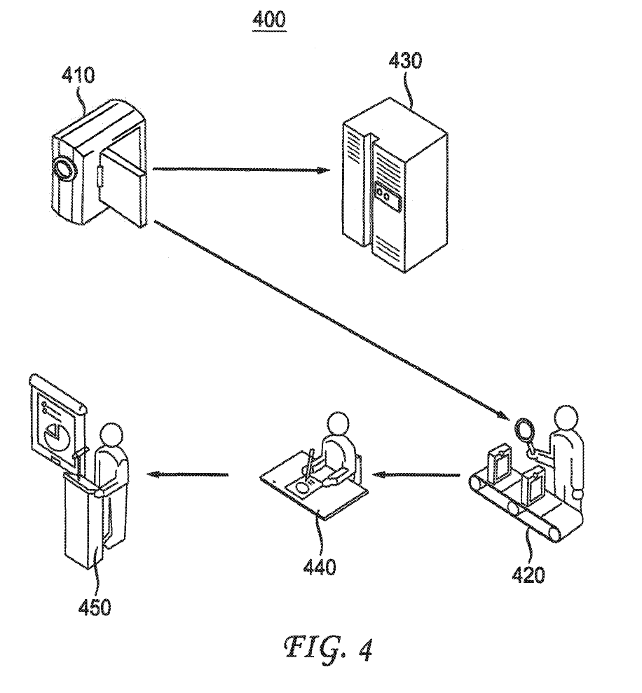

Referring now to FIG. 4, a block diagram of an exemplary live video feed system 400 according to the present invention is shown. The live video feed system 400 is operative to receive a 3D video stream with either two separate channels for left and right eye or one frame compatible feed 410. An operator initiates a prequalification review of the content 420. They analyst may adjust parameters of the automated analysis and or limit particular functions to ensure real time performance. The system may record content and/or depth map to a storage medium for later detailed analysis 430. The analyst then prepares the certification report 440 and returns the report to the customer 450. These steps may be automated.

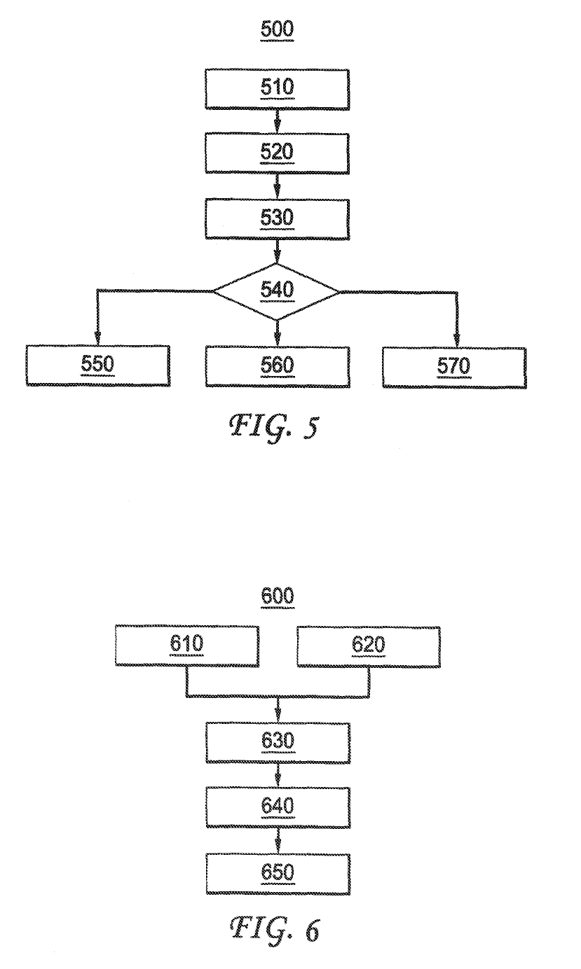

Referring now to FIG. 5 a flowchart that illustrates an exemplary embodiment of a 3D visualization system for the disparity map 500 according to the present invention is shown. The 3D visualization system contains 3D surface visualization for disparity map, 3D bar visualization for the disparity map and the 3D line meshing visualization for the disparity map. Based on the 3D visualization system, a user can analyze the disparity map of a stereo content, and then adjusting for different viewing environments to promote comfortable viewing standards.

First, a disparity map is input into the 3D visual system 510. Second, a sparse sampling was applied to the input disparity map 520. The sparse sampling is a similar to a down sampling procedure. The difference is that the sparse sampling will take the extra filter to smoothen the input disparity map. Next, a color bar map is generated 530. Next a choice is made to select between three different display modes 540. The three different display modes are generated by three different 3D visualization procedures which will process the disparity map to illustrate the final visualization of disparity map. Three possible display modes include 3D surface visualization of disparity map 550, 3D bar visualization for disparity map 560, and 3D line meshing visualization of disparity map 570. The three different visualization processes are described further with respect to the following figures.

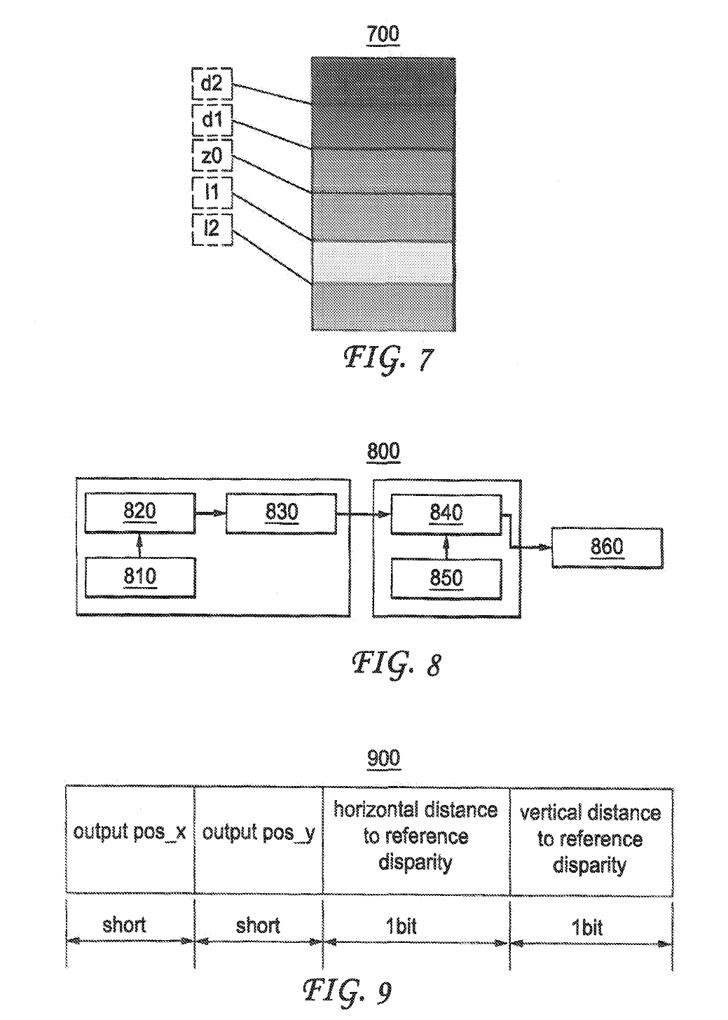

The color bar texture generation (600, FIG. 5 530) is performed to generate the different colors to distinguish warning and error levels. To generate the color bar textures, the range of hyper convergence 610 and the range of hyper divergence 620 are input to the color range division. The color range division 630 takes the warning level and error level from the range of hyper divergence to determine the bottom side of color range map shown in FIG. 7. The same operation is applied to the range of hyper convergence to determine the top side of color range map. The system according to the present invention may, for example, divide the index into levels such as hyper diverge error, hyper diverge warn, disparity at 0, hyper converge warn, hyper converge error to indicate the index of different levels for hyper diverge, hyper converge, and highest acceptable disparity.

Referring now to FIG. 7, an example of the color map texture 700 is shown. The threshold of level is indicated next to the texture (d2, D1, z0, I1,I2). Besides the threshold table, a color table is also designed to generate interrelation color map texture. To produce a gradient color, the present disclosure subdivides each interval into smaller segments so each segment can represent one color. All of these segments are be interpolated from the start of interval and end of interval. For example, the interval between d2 and d1 can be divided into 16 segments, and the segment would be interpolated based on d2 and d1.

Referring now to FIG. 8, the workflow of disparity map visualization in 3D surface 800 is shown. The disparity display processing unit 820 receives the disparity map texture 810 to generate the z depth for the display 830. The rasterization procedure 840 uses the color map texture 850 to find the index of color pixel range and through the index to look up the proper value from the color map index. The final visualization result is then displayed on a monitor 860.

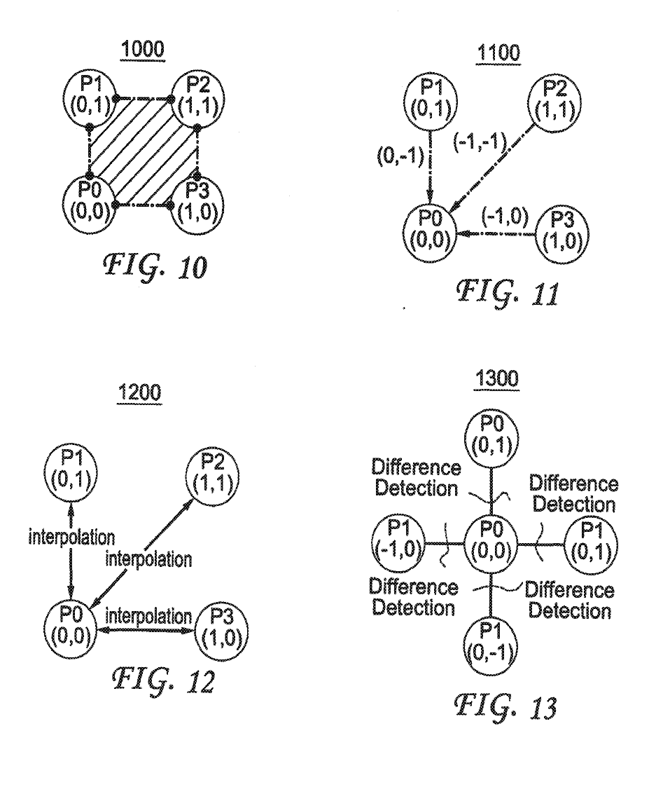

Turning now to FIG. 10, a display unit 1000 in the disparity display processing unit corresponding to a pixel in the disparity map is shown. The exemplary display unit has four vertexes. The data structure of each vertex contains the output position x standing for the horizontal direction, the output position y standing for the vertical position, the horizontal distance to the reference disparity, and the vertical distance to the reference disparity shown in FIG. 9. In FIG. 9, the data structure 900 of the vertex for the surface is shown. All of four vertexes in a display unit share the same disparity pixel to produce the flat surface.

In the graph of a display unit 1000 using the righthand coordinate system, PO stands for the position of the reference disparity pixel. The P1 is the top position of the reference disparity pixel, and P2 is the topright position of the reference disparity pixel, and P3 is the right position of the reference disparity pixel.

Referring to FIG. 11, the algorithm for finding the zdepth value 1100 is shown. For the integer disparity pixel, to get the disparity value of P0 for P1, P2 and P3, we use the third value and fourth value in the data structure of vertex data to subtract from the current position. For example, for P1, we subtract (0,−1) from the position of P1 to get the position of P0. And then, we can get the position of reference disparity pixel (P). We can use it to sample the disparity texture to get the reference disparity pixel. The reference disparity pixel can be utilized to find the zdepth value.

Referring now to FIG. 12, an algorithm for generating the interpolated disparity pixel 1200 is shown. For the subpixel disparity pixel, to get the disparity value of P0 for P1, P2 and P3, we use the third value and fourth value in the data structure of vertex data to subtract from the current position. And then, we can get the position of reference disparity pixel (P0). We can use it to sample the disparity texture to get the reference disparity pixel. And an interpolation operation is applied on the reference disparity pixel and current disparity pixel to generate the interpolated disparity pixel.

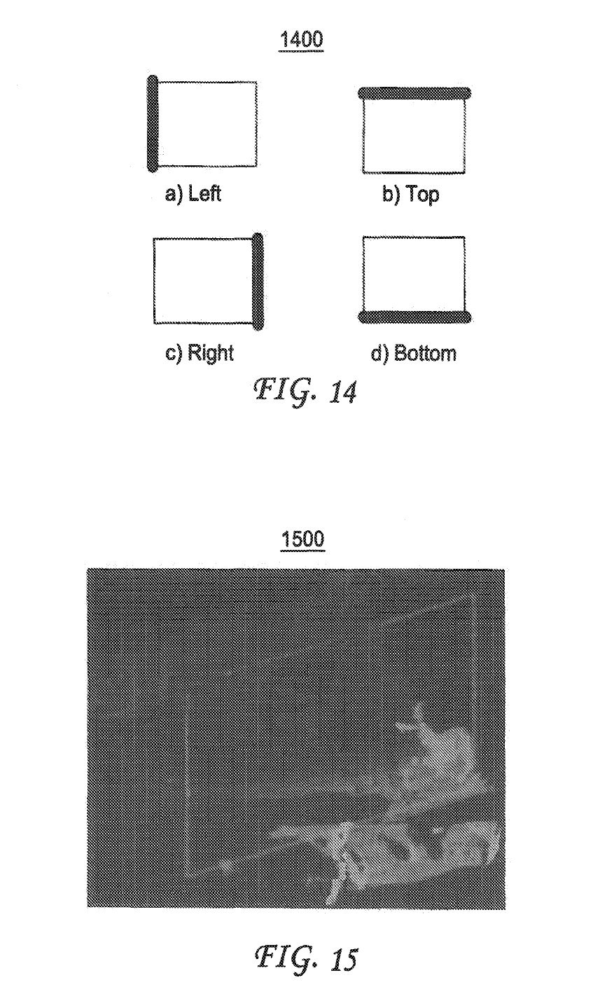

Referring now to FIG. 13, a contour map for a disparity surface 1300 is shown. Except for drawing the surface of disparity map, the system may also draw the contour when there exists a large difference between disparity pixels, which can be helpful to determine difference of disparity map. The system determines only one side contour in left, right, top and bottom order. That is, if there is more than one difference, the system only determines one side, since it can improve the visual quality. FIG. 14 depicts the drawing of the four possible side contours 1400ad.

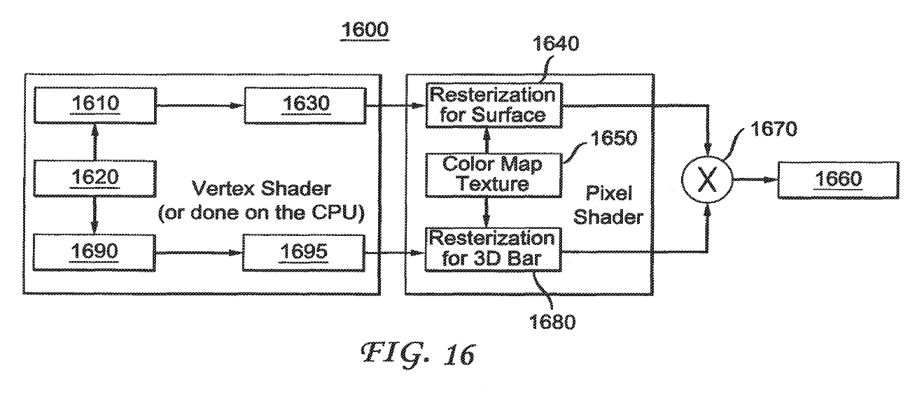

Referring now to FIG. 15, a graphical example of the 3D surface visualization for the disparity map 1500 is shown. Turning now to FIG. 16, the workflow for a disparity map visualization in 3D bar 16 is shown. The disparity display processing unit 1610 for receives the disparity map texture 1620 to generate the z depth for the display 1630. The disparity bar processing unit 1690 uses the disparity map texture 1620 to generate the bar unit vertex 1695, The rasterization procedure for the surface 1640 uses the color map texture 1650 to find the index of color pixel range and through the index to look up the proper value from the color map index. The rasterization procedure for the 3D bar 1680 uses the color map texture 1650 to generate the 3D bar. The 3D bar will blend 1670 with the surface to give the final 3D bar visualization of disparity map. The final visualization result is then displayed on a monitor 1660.

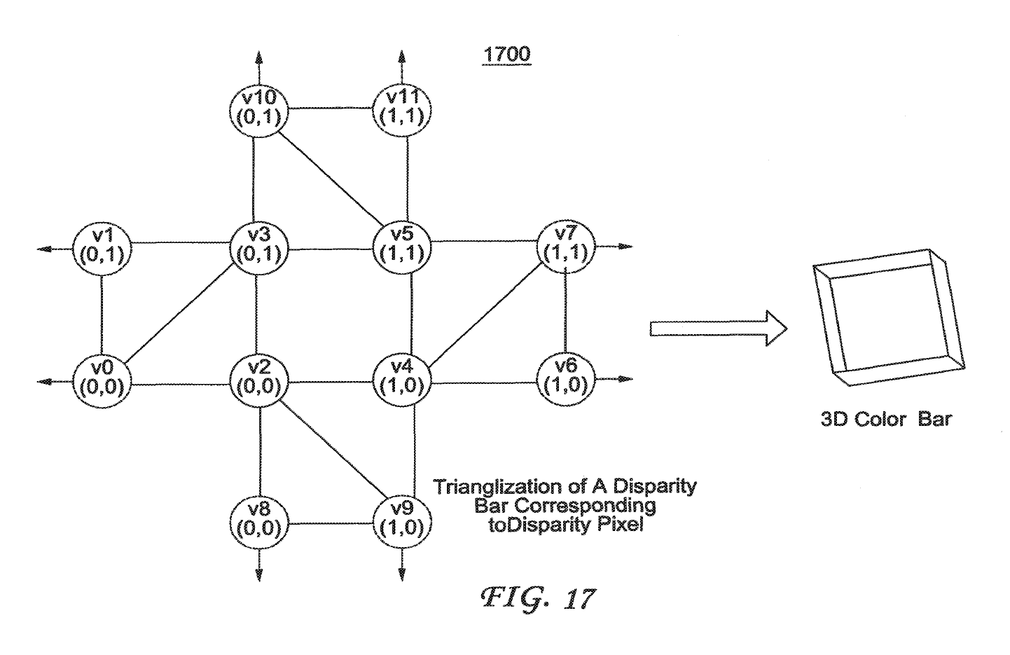

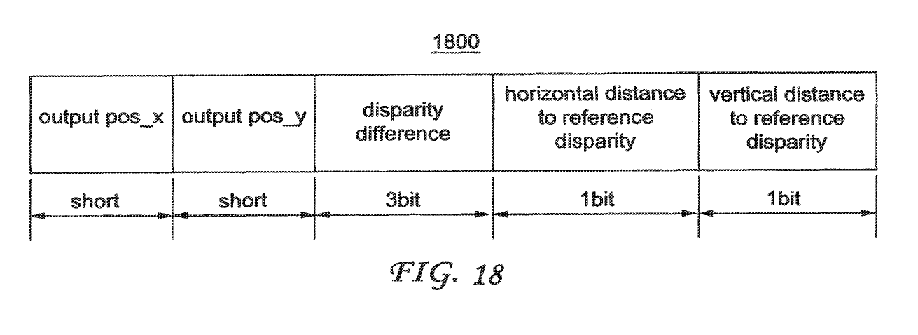

Turning now to FIG. 17, a disparity display processing unit 1700 corresponding to a pixel in the disparity map is shown. One display unit has twelve vertexes. A graph of a bar display unit 1700 using the righthand coordinate system is shown. The v2 stands for the position of the reference disparity pixel. The relations between the position of the reference disparity pixel and positions of other vertexes are shown. Referring now to FIG. 18, the data structure 1800 of each vertex is shown. The data structure contains the output position x standing for the horizontal direction, the output position y standing for the vertical position, the horizontal distance to the reference disparity, disparity difference and the vertical distance to the reference disparity.

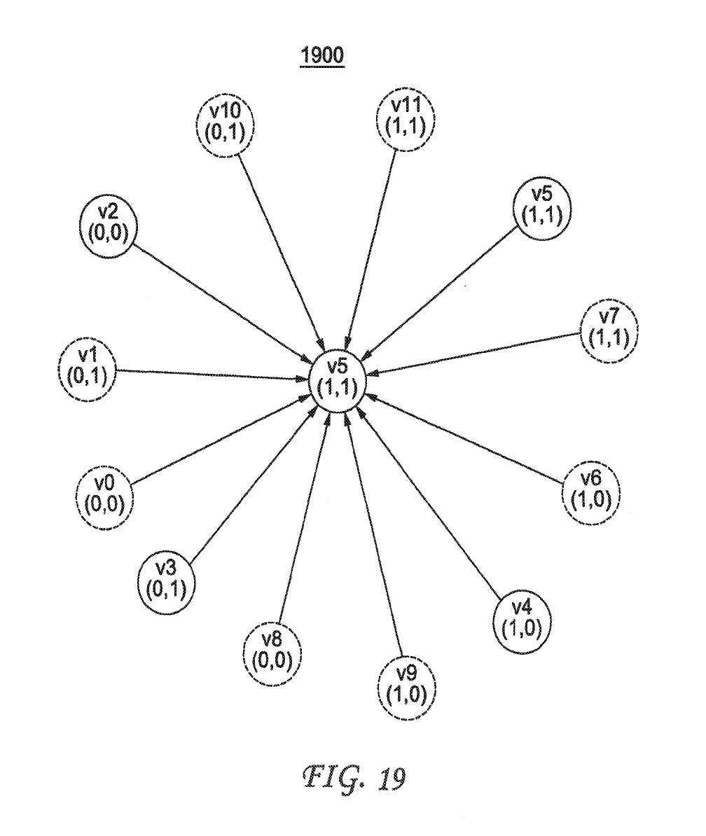

Referring now to FIG. 19, an example of a graph of an interpolation of the relation between the position of reference disparity vertex and connected vertexes is shown. If, for example, the v0 is the bottom position (in the third dimension) of the reference disparity pixel v2. All of vertexes except for v2 will refer to v2 and use the disparity pixel of v2 to make interpolation as shown.

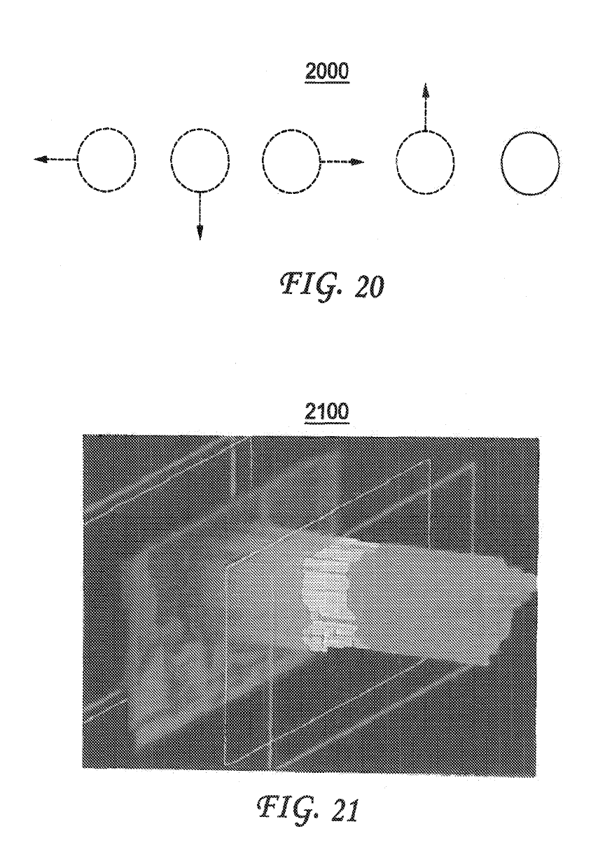

Referring now to FIG. 20, and example of a procedure for side bar 2000 drawing is shown. The system may use the stepup method to display the bar map. The stepup means that we only draw the bar when there is the difference between the current position of a disparity pixel and its neighbor disparity pixels. It can give an easy view visual result for the 3D disparity bar. Only the vertexes in the beginning of bar, v0, v1, v6, v7, v8, v9, v10 and v11 in dotted line, will compute the difference with the neighbor disparity pixels. The direction of difference computation is first to compare 2010 with the left disparity v0, v1. Next, the system compares 2020 with the bottom disparity v8,v9. Next, the system compares 2030 with the right disparity v6, v7. Next the system compares with the top disparity v10, v11. Finally, in the bar display unit, v2, v4, v3 and v5 in solid line are the vertexes on the ending of bar, so these vertexes will not involve into the difference computation. Referring now to FIG. 21, an example of the 3D bar visualization result for the disparity map 2100 is shown.

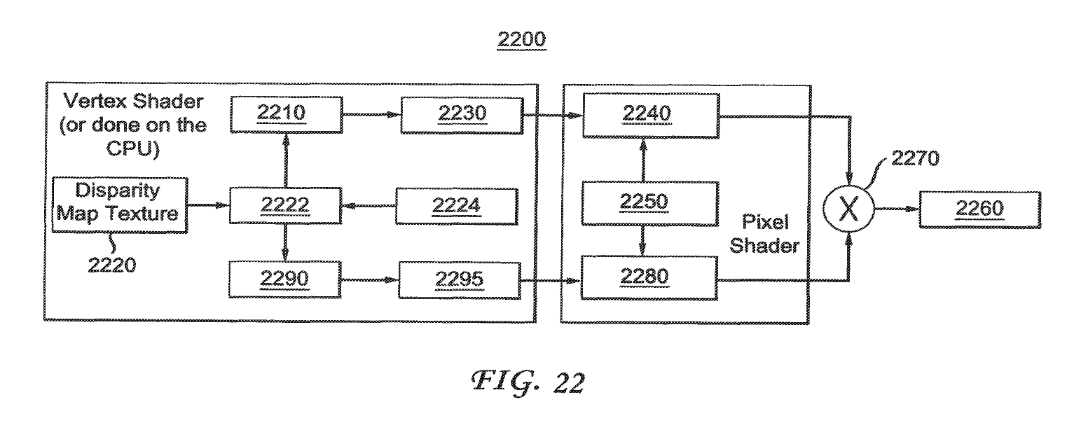

Referring now to FIG. 22, a Workflow of Disparity Map Visualization in 3D Line Meshing 2200 is shown.

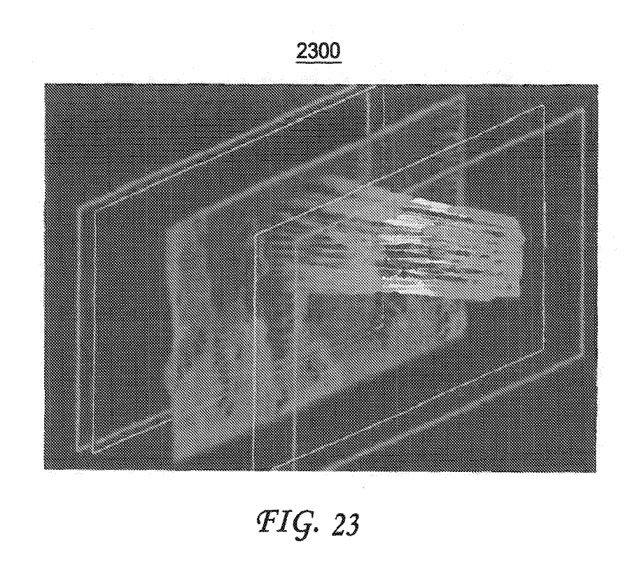

The disparity display processing unit 2210 for receives the disparity map texture 2220 from the low pass filter 2222 used to smoothen the disparity pixel to give continuous meshing appearance. The low pass filter 2222 is controlled in part by a line meshing control unit 2224 which control the various grain of meshing drawing. The disparity display processing unit 2210 uses smoothed disparity map texture to generate the z depth for the display 2230. The disparity bar processing unit 2290 uses the smoothed disparity map texture 2220 to generate the bar unit vertex 2295, The rasterization procedure for the surface 2240 uses the color map texture 2250 to find the index of color pixel range and through the index to look up the proper value from the color map index. The rasterization procedure for the 3D bar 2280 uses the color map texture 2250 to generate the 3D bar. The 3D bar will blend 2270 with the surface to give the final 3D bar visualization of disparity map. The final visualization result is then displayed on a monitor 2260. Referring to FIG. 23, an example of 3D line meshing visualization result 2300 for the disparity map is shown.

The present disclosure may be practiced, but is not limited to, using the following hardware and software: SITspecified 3D Workstation, one to three 2D monitors, a 3D Monitor (framecompatible and preferably framesequential as well), Windows 7 (for workstation version), Windows Server 2008 R2 (for server version), Linux (Ubuntu or CentOS), Apple Macintosh OSX, Adobe Creative Suite software and Stereoscopic Player software.

It should be understood that the elements shown in the figures may be implemented in various forms of hardware, software or combinations thereof. Preferably, these elements are implemented in a combination of hardware and software on one or more appropriately programmed generalpurpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for informational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herewith represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although embodiments which incorporate the teachings of the present disclosure have been shown and described in detail herein, those skilled in the art can readily devise many other varied embodiments that still incorporate these teachings. Having described preferred embodiments for a method and system for the 3D visualization of a disparity map (which are intended to be illustrative and not limiting), it is noted that modifications and variations can be made by persons skilled in the art in light of the above teachings.

1. A method comprising the steps of:
receiving a disparity map having a plurality of values;
selecting a portion of said plurality of values to generate a sparse disparity map;
filtering said values of said sparse disparity map to generate a smoothed disparity map;
generating a color map in response to a user input;
applying said color map to said smoothed disparity map to generate a visualization of said smoothed disparity map; and
displaying said visualization of said smoothed disparity map.

2. The method of claim 1 wherein said visualization is a surface map.

3. The method of claim 1 wherein said visualization is a bar map.

4. The method of claim 1 wherein said visualization is a mesh map.

5. The method of claim 1 wherein said color map is generated in response to a range of hyper divergence conditions.

6. The method of claim 1 wherein said color map is generated in response to a range of hyper convergence conditions.

7. The method of claim 1 further comprising the step of generating said disparity map in response to reception of a 3D video stream.

8. An apparatus comprising:
an input for receiving a disparity map having a plurality of values;
a processor for selecting a portion of said plurality of values to generate a sparse disparity map, filtering said values of said sparse disparity map to generate a smoothed disparity map, generating a color map in response to a user input, applying said color map to said smoothed disparity map to generate a visualization of said smoothed disparity map; and
a video processing circuit for generating a signal representative of said visualization of said smoothed disparity map.

9. The apparatus of claim 8 wherein said video processing circuit is a video monitor.

10. The apparatus of claim 8 wherein said video processing circuit is a video driver circuit.

11. The apparatus of claim 8 wherein said visualization is a surface map.

12. The apparatus of claim 8 wherein said visualization is a bar map.

13. The apparatus of claim 8 wherein said visualization is a mesh map.

14. The apparatus of claim 8 wherein said color map is generated in response to a range of hyper divergence conditions.

15. The apparatus of claim 8 wherein said color map is generated in response to a range of hyper convergence conditions.

16. The apparatus of claim 8 further comprising the step of generating said disparity map in response to reception of a 3D video stream.

17. A method of generating a visualization of a 3D disparity map comprising the steps of:
receiving a signal comprising a 3D image;
generating a disparity map from said 3D image, wherein said disparity map has a plurality of values;
selecting a portion of said plurality of values to generate a sparse disparity map;
filtering said values of said sparse disparity map to generate a smoothed disparity map;
generating a color map in response to a user input;
applying said color map to said smoothed disparity map to generate a visualization of said smoothed disparity map; and
generating a signal representative of said visualization of said smoothed disparity map.

18. The method of claim 17 further comprising the step of displaying said visualization of said smoothed disparity map.

19. The method of claim 17 wherein said visualization is a surface map.

20. The method of claim 17 wherein said visualization is a bar map.
